(19) United States
(12) Patent Application Publication
(10) Pub. No.: US 2014/0278939 A1
(43) Pub. Date: Sep. 18, 2014

(54) ADVERTISEMENT EXTRACTION DEVICE AND ADVERTISEMENT EXTRACTION METHOD

(71) Applicant: YAHOO JAPAN CORPORATION, Tokyo (JP)

(72) Inventors: Toru HOTTA, Tokyo (JP); Masashi TSUBOSAKA, Tokyo (JP); Shuhei UNO, Tokyo (JP); Koji TSUKAMOTO, Tokyo (JP)

(73) Assignee: YAHOO JAPAN CORPORATION, Tokyo (JP)

(21) Appl. No.: 14/152,360

(22) Filed: Jan. 10, 2014

(30) Foreign Application Priority Data
Mar. 18, 2013 (JP) 2013-054869

(51) Int. Cl. G06Q 30/02

(52) U.S. Cl. CPC G06Q 30/0246
USPC 705/14.45

(57) ABSTRACT

An advertisement extraction device according to the present application has a calculating unit, a tallying unit, and an extracting unit. The calculating unit calculates a hypothetical advertisement effect for each user attribute of a user, based on a delivery history regarding advertisement content delivery to a terminal device used by the user. The tallying unit tallies up an advertisement effect for each piece of advertisement content in which a user attribute as a delivery object has been decided, through the use of the hypothetical advertisement effect corresponding to the user attribute as the delivery object in the advertisement content among the hypothetical advertisement effects for each of the user attributes calculated by the calculating unit. The extracting unit extracts the advertisement content as a delivery candidate, based on the advertisement effect tallied up by the tallying unit.

### CROSS-REFERENCE TO RELATED APPLICATIONS

The present application claims priority to and incorporates by reference the entire contents of Japanese Patent Application No. 2013-054869 filed in Japan on Mar. 18, 2013.

### BACKGROUND OF THE INVENTION

1. Field of the Invention

The present invention relates to an advertisement extraction device and an advertisement extraction method.

2. Description of the Related Art

In recent years, with radical spread of the Internet, advertisement delivery through the Internet has been actively performed. For example, there is advertisement delivery in which advertisement content (e.g., an icon of an image or the like) of a company, a commercial product or the like is displayed at a predetermined position on a web page, and when the advertisement content is clicked on, the display shifts to a web page of an advertiser.

The above-described advertisement content is often delivered by an advertisement delivery device retaining the advertisement content submitted by the respective advertisers. For example, the advertisement delivery device may extract the advertisement content as delivery candidates in an order of a higher bidding price specified by the advertiser from an enormous amount of advertisement content, and may extract the advertisement content having a high advertisement effect (e.g., CTR: Click Through Rate) or the like as a delivery object from the extracted advertisement content. In this manner, it can be considered that the advertisement delivery device narrows the advertisement content as the delivery candidates, based on the bidding price as static information, which can reduce a processing load on the advertisement delivery.

However, in the above-described related art, the advertisement content having the high advertisement effect is not necessarily delivered. Specifically, as in the above-described related art, when the advertisement content as the delivery candidates is narrowed, based on the bidding price, the narrowed advertisement content is not necessarily clicked on by a user. That is, in the above-described related art, at a time point when the advertisement content as the delivery candidates is narrowed from the enormous amount of advertisement content, the advertisement content having the high advertisement effect (i.e., the advertisement content that tends to be clicked on) may be excluded from delivery objects, and thus, the advertisement content having the high advertisement effect is not necessarily delivered.

### SUMMARY OF THE INVENTION

It is an object of the present invention to at least partially solve the problems in the conventional technology.

According to one aspect of an embodiment, an advertisement extraction device includes a calculating unit configured to calculate a hypothetical advertisement effect for each user attribute of a user, based on a delivery history regarding advertisement content delivery to a terminal device used by the user; a tallying unit configured to tally up an advertisement effect for each piece of advertisement content in which a user attribute as a delivery object has been decided, the tallying unit tallying up the advertisement effect through the use of the hypothetical advertisement effect corresponding to the user attribute as the delivery object in the advertisement content among the hypothetical advertisement effects for each user attribute calculated by the calculating unit; and an extracting unit configured to extract the advertisement content as a delivery candidate, based on the advertisement effect tallied up by the tallying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating one example of advertisement extraction processing according to an embodiment;

FIG. 2 is a diagram illustrating a configuration example of an advertisement delivery system according to the embodiment;

FIG. 3 is a diagram illustrating a configuration example of an advertisement delivery device according to the embodiment;

FIG. 4 is a diagram illustrating one example of an advertisement content storage unit according to the embodiment;

FIG. 5 is a diagram illustrating one example of a delivery history storage unit according to the embodiment;

FIG. 6 is a diagram illustrating one example of a virtual CTR storage unit according to the embodiment;

FIG. 7 is a flowchart illustrating a virtual CTR calculation processing procedure by the advertisement delivery device according to the embodiment;

FIG. 8 is a flowchart illustrating an advertisement delivery processing procedure by the advertisement delivery device according to the embodiment; and

FIG. 9 is a diagram schematically illustrating virtual CTR models generated by a calculating unit according to the embodiment.

### DETAILED DESCRIPTION OF THE PREFERRED EMBODIMENTS

Hereinafter, preferred embodiments for carrying out an advertisement extraction device, an advertisement extraction method, and an advertisement extraction program according to the present application (hereinafter, referred to as “embodiments”) will be described in detail with reference to the drawings. These embodiments do not limit the advertisement extraction device, the advertisement extraction method, and the advertisement extraction program according to the present application. In the following respective embodiments, the same units are given the same numbers and signs, and redundant descriptions are omitted.

1. Advertisement Extraction Processing

First, referring to FIG. 1, one example of advertisement extraction processing according to the embodiment will be described. FIG. 1 is an explanatory diagram illustrating one example of the advertisement extraction processing according to the embodiment. In the example of FIG. 1, the advertisement extraction processing is performed by an advertisement delivery device 100. The advertisement delivery device 100 illustrated in FIG. 1 accepts submission of advertisement content from advertiser devices 10₁-10ₙ used by advertisers, and stores the accepted advertisement content in an advertisement content storage unit 121. The advertisement delivery device 100, when receiving an acquisition request of the advertisement content from a terminal device 20 or the like used by the user, delivers the predetermined advertisement content from the advertisement content stored in the advertisement content storage unit 121 to the terminal device 20 or the like.

Here, the advertisement delivery device 100 according to the embodiment, when delivering the advertisement content to the terminal device 20, records a delivery history regarding the delivery of the advertisement content on a delivery history storage unit 131. As described below, the advertisement delivery device 100 performs virtual CTR calculation processing, in which for each user attribute of users, who were delivery destinations of the advertisement content in the past, a rate at which the users having the user attribute click on the advertisement content is calculated as a hypothetical CTR (may be represented by a virtual CTR), based on the delivery history. When receiving the acquisition request of the advertisement content from the terminal device 20, the advertisement delivery device 100 performs the advertisement extraction processing of extracting the advertisement content as a delivery candidate, based on the virtual CTR. The advertisement delivery device 100 performs the virtual CTR calculation processing and the advertisement extraction processing in different phases. Specifically, the advertisement delivery device 100 periodically performs the virtual CTR calculation processing to thereby calculate the virtual CTR, and performs the advertisement extraction processing, using the calculated virtual CTR. Hereinafter, the processing by the advertisement delivery device 100 will be described with reference to FIG. 1.

First, the virtual CTR calculation processing will be described. Here, it is assumed that the advertisement delivery device 100 retains the delivery histories illustrated in the delivery history storage unit 131 of FIG. 1. For example, a first line of the delivery history in FIG. 1 indicates that the advertisement content delivered to a user whose user attributes are “male” and “10's” (an age, the same applies hereinafter) has not clicked on (pressed) by the user. Moreover, for example, a second line of the delivery history in FIG. 1 indicates that the advertisement content delivered to a user whose user attributes are the “male” and the “10's” has clicked on (pressed) by the user. “Car” illustrated in the delivery history storage unit 131 of FIG. 1 corresponds to the user attribute indicating that a user thereof is interested in a car, “traveling” corresponds to the user attribute indicating that a user thereof is interested in traveling, and “Tokyo” corresponds to the user attribute indicating that a user thereof lives in Tokyo.

On the basis of the single user attribute included in the above-described delivery history, the advertisement delivery device 100 calculates, as the virtual CTR, a rate of a number of times of click on the advertisement content by users to a number of times of delivery of the advertisement content (referred to as a number of impressions or the like) to the users having the relevant user attribute. For example, it is assumed that in the delivery history storage unit 131, 1000 records exist in the delivery history including the user attribute “male”, and that 20 records of the 1000 records indicate “click is present”. In this case, the advertisement delivery device 100, 20 is divided by 1000 to calculate the virtual CTR “0.02” corresponding to the user attribute “male”. This virtual CTR “0.02” corresponds to an index value indicating at what rate the users having the attribute “male” click on the advertisement content”.

Similarly, the advertisement delivery device 100 calculates the virtual CTRs for the other user attributes “female”, “10's”, “20's”, “car”, “traveling” and the like. The advertisement delivery device 100 stores the user attributes and the virtual CTRs in association with each other in a virtual CTR storage unit 132 (step S11). As described above, the advertisement delivery device 100 periodically performs the above-described virtual CTR calculation processing, by which the virtual CTR storage unit 132 is periodically updated.

Subsequently, the advertisement extraction processing will be described. First, an assumption is that in the advertisement content storage unit 121 included in the advertisement delivery device 100, an enormous amount (e.g., several million pieces) of advertisement content submitted from the advertiser devices 10₁-10ₙ is stored. For each piece of the advertisement content, the user attribute as a delivery object is specified by each of the advertisers. For example, the advertiser related to automobiles specifies the delivery of the advertisement content to the users whose user attribute is the “male”, and submits the advertisement content of his or her company. In the following, the user attribute as the delivery object specified by the advertiser may be represented as a targeting condition.

Under the above-described assumption, when receiving an acquisition request of the advertisement content from the terminal device 20, the advertisement delivery device 100 extracts, from the several million pieces of advertisement content stored in the advertisement content storage unit 121, a predetermined number of (e.g., several ten thousand) pieces of advertisement content whose targeting condition matches the user attribute of the user using the terminal device 20 (step S21). In the example of FIG. 1, it is assumed that the user attribute of the user who has transmitted the acquisition request of the advertisement content is the “male”, and that the advertisement delivery device 100 extracts an advertisement content group G11 including the “male” as the targeting condition from the advertisement content storage unit 121. In FIG. 1, rectangles inside the advertisement content group G11 each indicate the advertisement content, and the “male” or the like represented inside each of the rectangles indicates the targeting condition.

Subsequently, the advertisement delivery device 100 extracts an advertisement content group G12 as delivery candidates from the advertisement content group G11, based on the virtual CTR stored in the virtual CTR storage unit 132 (step S22).

Specifically, the advertisement delivery device 100 acquires the virtual CTRs corresponding to the targeting condition from the virtual CTR storage unit 132 for each piece of the advertisement content included in the advertisement content group G11, and calculates a sum of the acquired virtual CTRs (hereinafter, may be represented as an “advertisement score”). For example, if the targeting condition of the advertisement content is the “male” and the “10's”, the advertisement delivery device 100 acquires, from the virtual CTR storage unit 132, the virtual CTR “0.02” corresponding to the user attribute “male” and the virtual CTR “0.04” corresponding to the user attribute “10's”, and adds all the acquired virtual CTRs to thereby calculate the advertisement score “0.06”. In this manner, the advertisement delivery device 100 tallies up the advertisement scores in all pieces of the advertisement content included in the advertisement content group G11. The advertisement delivery device 100 extracts the predetermined number of pieces of advertisement content from the advertisement content group G11 in an order of the higher advertisement score. In FIG. 1, the advertisement delivery device 100 extracts the advertisement content group G12 including about 100 pieces of the advertisement content without extracting the advertisement content whose targeting condition is the “male” and the “traveling”, and the like.

Subsequently, the advertisement delivery device 100 selects the advertisement content as the delivery objects from the advertisement content group G12, based on an actual CTR or the like of each piece of the advertisement content. Processing for selecting the advertisement content as the delivery objects will be described later. The advertisement delivery device 100 delivers the advertisement content selected in this manner to the terminal device 20.

In this manner, since the advertisement delivery device 100 according to the embodiment narrows the advertisement content from the advertisement content group G11 to the advertisement content group G12, using the virtual CTR, the advertisement content having a high advertisement effect can be delivered. For example, if the advertisement content is narrowed from the advertisement content group G11 to the advertisement content group G12, based on a bidding price specified by the advertiser, the advertisement effect of each piece of the advertisement content is not necessarily high. In this case, the advertisement effects of the advertisement content as the delivery objects selected from the advertisement content group G12 are not necessarily high, either, and as a result, the advertisement content having the high advertisement effect is not necessarily delivered. However, in the advertisement delivery device 100 according to the embodiment, since the use of the virtual CTR enables the advertisement content to be narrowed to the advertisement content group G12, which can tend to be clicked on, the advertisement content having the high advertisement effect can be delivered.

Moreover, it is generally, assumed that the advertisement content whose targeting condition is specified in more detail has the higher advertisement effect because targeting accuracy is increased. Since the advertisement delivery device 100 according to the embodiment adds the virtual CTRs corresponding to the targeting condition, the advertisement content whose targeting condition is specified in more detail has the higher advertisement score calculated. Therefore, since the advertisement delivery device 100 preferentially extracts the advertisement content assumed to have the higher advertisement effect as the delivery candidates, the advertisement content having the high advertisement effect can be delivered.

Moreover, since the advertisement delivery device 100 according to the embodiment periodically calculates the virtual CTRs for each user from the delivery history, the virtual CTR calculation processing need not be performed every time the advertisement extraction processing is performed. Thus, the advertisement delivery device 100 can reduce a load on the advertisement extraction processing, and can prevent the advertisement extraction processing from being delayed. Hereinafter, the advertisement delivery device 100 that performs the above-described advertisement extraction processing will be described in detail.

2. Configuration of Advertisement Delivery System

Next, referring to FIG. 2, a configuration of an advertisement delivery system according to the embodiment will be described. FIG. 2 is a diagram illustrating a configuration example of an advertisement delivery system 1 according to the embodiment. As illustrated in FIG. 2, the advertisement delivery system 1 includes the advertiser devices 10₁-10ₙ, the terminal device 20, an information providing device 30, and the advertisement delivery device 100. The advertiser devices 10₁-10ₙ, the terminal device 20, the information providing device 30 and the advertisement delivery device 100 are communicably connected by wired or wireless connection through a network N. The advertisement delivery system 1 illustrated in FIG. 2 may include a plurality of terminal devices 20, a plurality of information providing devices 30, and a plurality of advertisement delivery devices 100.

The advertiser devices 10₁-10ₙ are information processing devices used by the advertisers who request the advertisement delivery to the advertisement delivery device 100. The above-described advertiser devices 10₁-10ₙ submit the advertisement content to the advertisement delivery device 100 in accordance with operation by the advertisers. For example, the advertiser devices 10₁-10ₙ submit, to the advertisement delivery device 100, the advertisement content corresponding to still images, moving images, text data, URLs (Uniform Resource Locators) or the like for accessing web pages provided by advertiser servers administered by the advertisers. The advertisers may request the submission of the advertisement content to agencies in place of submitting the advertisement content to the advertisement delivery device 100, using the advertiser devices 10₁-10ₙ. In this case, the agencies submit the advertisement content to the advertisement delivery device 100. Hereinafter, notation of the “advertiser” is a concept including not only the advertiser but the agency, and the notation of the “advertiser device” is a concept including not only the advertiser device but an agency device used by the agency. Moreover, since the advertiser devices 10₁-10ₙ have similar functions, respectively, hereinafter, when the advertiser devices 10₁-10ₙ need not be distinguished from one another, these may be collectively represented as an “advertiser device 10”.

The terminal device 20 is an information processing device such as, for example, a desktop PC (Personal Computer), a laptop PC, a tablet terminal, a portable telephone, a PDA (Personal Digital Assistant) and the like. For example, the terminal device 20 accesses the information providing device 30 to thereby acquire a web page from the information providing device 30 and display the acquired web page on a display device (e.g., a liquid crystal display). Moreover, when an advertisement space is included in the web page, the terminal device 20 accesses the advertisement delivery device 100 to thereby acquire the advertisement content from the advertisement delivery device 100 and display the acquired advertisement content on the web page. However, the present embodiment is not limited to this example, but the terminal device 20 may acquire the web page including the advertisement content from the information providing device 30. In this case, the information providing device 30 delivers, to the terminal device 20, the web page incorporating the advertisement content provided by the advertisement delivery device 100.

The information providing device 30 is a web server or the like that provides the web page to the terminal device 20. The above-described information providing device 30 provides various types of web pages regarding, for example, a news site, an auction site, a weather forecast site, a shopping site, a finance (stock price) site, a route search site, a map providing site, a traveling site, a restaurant introduction site, a weblog and the like.

The advertisement delivery device 100 is a server device that delivers the advertisement content submitted from the advertiser device 10. As described above, the advertisement delivery device 100 delivers the advertisement content to the terminal device 20, when accessed by the terminal device 20. Moreover, the advertisement delivery device 100 delivers the advertisement content to the information providing device 30, when accessed by the information providing device 30.

3. Configuration of Advertisement Delivery Device

Next, referring to FIG. 3, a configuration of the advertisement delivery device 100 according to the embodiment will be described. FIG. 3 is a diagram illustrating a configuration example of the advertisement delivery device 100 according to the embodiment. As illustrated in FIG. 3, the advertisement delivery device 100 has a communication unit 110, the advertisement content storage unit 121, the delivery history storage unit 131, the virtual CTR storage unit 132, and a control unit 140. The advertisement delivery device 100 may have an input unit (e.g., a keyboard, a mouse and the like) that accepts various types of operation from an administrator or the like using the advertisement delivery device 100, a display unit for displaying various types of information (e.g., a liquid crystal display and the like).

Communication Unit 110

The communication unit 110 is implemented by a NIC (Network Interface Card) or the like. The above-described communication unit 110 is connected to the network N in the wired or wireless connection, and transmission and reception of information is performed among the advertiser device 10, the terminal device 20 and the information providing device 30 through the network N.

Storage Unit

The advertisement content storage unit 121, the delivery history storage unit 131 and the virtual CTR storage unit 132 are implemented, for example, by a semiconductor memory element such as a RAM (Random Access Memory), a flash memory and the like, or a storage device such as a hard disk, an optical disk and the like.

Advertisement Content Storage Unit 121

The advertisement content storage unit 121 stores the advertisement content submitted from the advertiser device 10. Here, in FIG. 4, one example of the advertisement content storage unit 121 according to the embodiment is illustrated. In the example illustrated in FIG. 4, the advertisement content storage unit 121 has items of “advertiser ID”, “advertisement content”, “targeting condition”, “bidding price”, “keyword”, and “CTR”.

The “advertisement ID” indicates identification information for identify the advertiser or the advertiser device 10. The “advertisement content” indicates the advertisement content submitted from the advertiser device 10. While in the example illustrated in FIG. 4, an example in which conceptual information such as “C11” and “C12” is stored as the advertisement content of the advertisement content storage unit 121 is illustrated, actually, still images, moving images, text data and URLs or file path names indicating storage locations of these files, or advertisement IDs for identifying the advertisement content, and the like are stored.

The “targeting condition” indicates a condition of the user as the delivery object of the advertisement content, and is specified by the advertiser at the time of submission of the advertisement content. For example, in the “targeting condition”, the user attribute of the user as the delivery object of the advertisement content is stored. The “bidding price” indicates an advertisement rate specified when the advertiser submits the advertisement content, and for example, corresponds to a unit price to be paid to an advertisement deliverer (e.g., an administrator of the advertisement delivery device 100) from the advertiser when the advertisement content is clicked on once by the user. While in the example illustrated in FIG. 4, an example in which conceptual information such as “M11” and “M12” is stored as the bidding price of the advertisement content storage unit 121 is illustrated, actually, numerical values each indicating a money amount are stored.

The “keyword” is a character string or the like extracted from the advertisement content, and corresponds to a character string indicating a field and characteristics of the advertisement content. As in the example illustrated in FIG. 4, a plurality of keywords may be stored in one piece of the advertisement content. The “CTR” indicates an actual advertisement effect when the advertisement content is delivered to the terminal device 20. As the CTR of the advertisement content that has never been delivered to the terminal device 20, there are stored a fixed value decided in advance, an average value of the CTRs in all pieces of the advertisement content, an average value of the CTRs in all pieces of the advertisement content belonging to the same advertisement category (e.g., car, traveling) and the like.

That is, in FIG. 4, an example is illustrated, in which the advertiser identified by the advertiser ID “A10” specifies the user attributes “male” and “10's” as the targeting condition, and specifies M11 as the bidding price, and then submits the advertisement content “C11”. Moreover, FIG. 4 illustrates that the keywords extracted from the advertisement content “C11” are “car” or “black”, and that the relevant advertisement content was delivered to the terminal device 20, and a result, the CTR was “0.02”.

Delivery History Storage Unit 131

The delivery history storage unit 131 stores the delivery histories regarding the advertisement delivery to the terminal devices 20. Here, in FIG. 5, one example of the delivery history storage unit 131 according to the present embodiment is illustrated. While the delivery history storage unit 131 may be configured by a table in a database as in the example illustrated in FIG. 5, actually, the delivery history storage unit 131 corresponds to a text file in which the delivery histories (a log regarding the advertisement delivery) are written or the like. In the example illustrated in FIG. 5, the delivery history storage unit 131 has items of “delivered advertisement content”, “delivery object user attribute”, and “presence/absence of click”.

The “delivered advertisement content” corresponds to the advertisement content illustrated in FIG. 4, and indicates the advertisement content that the advertisement delivery device 100 actually delivered to the terminal device 20. The “delivery object user attribute” indicates the user attributes of the user (terminal device 20) as a delivery destination of the delivered advertisement content. The “presence/absence of click” indicates whether or not the delivered advertisement content has been clicked by the user. In the example illustrated in FIG. 5, when the relevant advertisement content has been clicked on, “I (present)” is stored as the “presence/absence of click”, and when the relevant advertisement content has never been clicked on, “0 (absent)” is stored as the “presence/absence of click”.

That is, in FIG. 5, an example is illustrated, in which the advertisement content “C11” is delivered to the terminal device 20 of the user having the attributes-“male” and “10's”, and the delivered advertisement content “C11” has not been clicked on by the user.

Although the illustration is omitted in FIG. 3, the advertisement delivery device 100 retains a user information storage unit that stores the user attributes of each of the users in association with a user ID of each user. The user attributes stored in this user information storage unit are collected, based on web pages browsed by the user, information of commercial products purchased by the user through web pages. In the “delivery object user attribute” of the delivery history storage unit 131 are stored the user attributes of the user as the delivery destination of the delivered advertisement content among the user attributes stored in the above-described user information storage unit. However, the present embodiment is not limited to this example, but in the “delivery object user attribute” of the delivery history storage unit 131, the targeting condition of the delivered advertisement content may be stored, or both the user attributes of the user information storage unit and the targeting condition of the delivered advertisement content may be stored.

Virtual CTR Storage Unit 132

For each user attribute of the users to which the advertisement content is delivered from the advertisement delivery device 100, the virtual CTR storage unit 132 stores the virtual CTR, which is the rate at which the users having the relevant attribute click on the advertisement content. Here, in FIG. 6, one example of the virtual CTR storage unit 132 according to the embodiment is illustrated. In the example illustrated in FIG. 6, the virtual CTR storage unit 132 has items of “user attribute” and “virtual CTR”.

The “user attribute” corresponds to the individual user attribute included in the delivery object user attribute indicated in the delivery history storage unit 131, and, that is, indicates the user attribute of the user to which the advertisement content has been delivered. The “virtual CTR” indicates a rate of a number of times of the click on the advertisement content by the users among a number of times of advertisement delivery (the number of impressions) to the users having the “user attribute”. That is, FIG. 6 illustrates an example in which the users having the user attribute “male” click on the advertisement content with probability “0.02 (2%)”.

Control Unit 140

The control unit 140 is implemented, for example, by executing various types of programs (corresponding to one example of an advertisement extraction program) stored in a storage device inside the advertisement delivery device 100 with the RAM used as a work area by a CPU (Central Processing Unit), an MPU (Micro Processing Unit) or the like. Alternatively, the control unit 140 is implemented, for example, by an integrated circuit such as an ASIC (Application Specific Integrated Circuit), an FPGA (Field Programmable Gate Array) and the like.

The above-described control unit 140 has a submission acceptor 141, a receiving unit 142, an advertisement extracting unit 143, and a delivery unit 147 as illustrated in FIG. 3, and implements or executes a function and an action of information processing described below. An internal configuration of the control unit 140 is not limited to the configuration illustrated in FIG. 3, but any other configuration that performs the information processing described later may be employed. Connection relationships among the respective processing units that the control unit 140 has are not limited to connection relationships illustrated in FIG. 3, but other connection relationships may be employed.

Submission Acceptor 141

The submission acceptor 141 accepts the submission of the advertisement content from the advertiser device 10 to store the accepted advertisement content in the advertisement content storage unit 121. Specifically, when accepting the submission of the advertisement content together with the specification of the bidding price and the targeting condition from the advertiser device 10, the submission acceptor 141 extracts the keyword indicating the characteristics of the advertisement content from the submitted advertisement content. The submission acceptor 141 stores the bidding price, the targeting condition and the keyword in the advertisement content storage unit 121 together with the submitted advertisement content.

Several processings for extracting the keyword from the advertisement content by the submission acceptor 141 are considered. For example, in the case where the advertisement, content is an HTML (HyperText Markup Language) file, the submission acceptor 141 performs morphological analysis of a text described in the HTML file to extract a morpheme appearing at high frequency as the keyword, to extract a character string specified as a title of the HTML file as the keyword, or to extract metadata (e.g., a character string described in a meta tag) of the HTML file as the keyword. Moreover, for example, in the case where the advertisement content is image data, the submission acceptor 141 extracts metadata of the image data as the keyword.

Moreover, for example, the submission acceptor 141 may accept the submission of the keyword together with the advertisement content from the advertiser (the advertiser device 10) in place of extracting the keyword from the advertisement content. In this case, the submission acceptor 141 stores the keyword submitted from the advertiser in the advertisement content storage unit 121.

Receiving Unit 142

The receiving unit 142 receives the acquisition request of the advertisement content from the terminal device 20 or from the information providing device 30. For example, the receiving unit 142 receives the acquisition request of the advertisement content by an HTTP (Hypertext Transfer Protocol) request or the like.

The device that transmits the acquisition request of the advertisement content to the receiving unit 142 differs, depending on a web page that is delivered by the information providing device 30. For example, in the case where a web page in which an URL for accessing the advertisement delivery device 100 is embedded is delivered to the terminal device 20, the receiving unit 142 receives the acquisition request of the advertisement content from the terminal device 20. Moreover, in the case where a web page in which the advertisement content has already been embedded is delivered to the terminal device 20, the receiving unit 142 receives the acquisition request of the advertisement content from the information providing device 30.

Advertisement Extracting Unit 143

When the acquisition request of the advertisement content is received by the receiving unit 142, the advertisement extracting unit 143 extracts the advertisement content from the advertisement content storage unit 121. The above-described advertisement extracting unit 143 has a calculating unit 144, a tallying unit 145, and an extracting unit 146, as illustrate in FIG. 3.

Calculating Unit 144

The calculating unit 144 calculates the virtual CTR for each user attribute, based on the delivery history stored in the delivery history storage unit 131, and stores the calculated virtual CTR in the virtual CTR storage unit 132.

Specifically, on the basis of the single user attribute included in the delivery object user attribute, the calculating unit 144 acquires the delivery histories including the relevant user attribute from the delivery history storage unit 131. Subsequently, the calculating unit 144 divides a number of the delivery histories in which the presence/absence of click is 1 (present) among the acquired delivery histories by a total number of the acquired delivery histories, by which the virtual CTR for each user attribute is calculated.

For example, it is assumed that in the example illustrated in FIG. 5, the calculating unit 144 calculates the virtual CTR corresponding to the user attribute “male” included in the delivery object user attribute. In this case, since the “male” is included in the delivery object user attribute on the first line stored in the delivery history storage unit 131, the calculating unit 144 acquires the delivery history on the first line from the delivery history storage unit 131. Similarly, the calculating unit 144 acquires the delivery histories on the second to fourth, seventh, and eighth lines including the “male” in the delivery object user attribute. Subsequently, the calculating unit 144 counts the number of the delivery histories in which the presence/absence of click is “1 (present)” among the delivery histories acquired from the delivery history storage unit 131. The calculating unit 144 divides the count result by the total number of the delivery histories acquired from the delivery history storage unit 131, by which the virtual CTR corresponding to the user attribute “male” is calculated. In this manner, the calculating unit 144 calculates the respective virtual CTRs corresponding to the other user attributes “female”, “10's”, “20's”, “Tokyo” and the like, and updates the virtual CTR storage unit 132.

As described above, the calculating unit 144 periodically performs the above-described virtual CTR calculation processing, and periodically updates the virtual CTR storage unit 132. In other words, the calculating unit 144 performs the virtual CTR calculation processing at predetermined timing decided in advance (e.g., every day, every week), whether or not the acquired request of the advertisement content has been received by the receiving unit 142.

Tallying Unit 145

The tallying unit 145 tallies up the advertisement score of each piece of advertisement content, based on the virtual CTR for each user attribute calculated by the calculating unit 144. The tallying unit 145 according to the embodiment tallies up the advertisement scores for the advertisement content group (corresponding to the advertisement content group G11 in FIG. 1) resulting from narrowing the advertisement content groups stored in the advertisement content storage unit 121 to the predetermined number by the extracting unit 146 described later.

Here, one example of tallying processing by the tallying unit 145 will be described. For each piece of the advertisement content narrowed by the extracting unit 146, the tallying unit 145 acquires the targeting condition corresponding to the relevant advertisement content from the advertisement content storage unit 121. The tallying unit 145 acquires, from the virtual CTR storage unit 132, the virtual CTRs corresponding to the targeting condition acquired from the advertisement content storage unit 121 to tally up a sum of the acquired virtual CTRs as the advertisement score.

For example, it is assumed that the advertisement content storage unit 121 is in a state illustrated in FIG. 4, and that the virtual CTR storage unit 132 is in a state illustrated in FIG. 6. Moreover, it is assumed that the advertisement content “C12” is included in the advertisement content group resulting from narrowing by the extracting unit 146. In this case, the tallying unit 145 acquires the targeting condition “male, 20's, car” corresponding to the advertisement content “C12” from the advertisement content storage unit 121. Subsequently, the tallying unit 145 acquires, from the virtual CTR storage unit 132, the virtual CTR “0.02” of the user attribute matching the targeting condition “male”, the virtual CTR “0.03” of the user attribute matching the targeting condition “20's”, and the virtual CTR “0.05” of the user attribute matching the targeting condition “car”. The tallying unit 145 adds all the acquired virtual CTRs “0.02”, “0.03”, and “0.05” to thereby find the advertisement score “0.10” corresponding to the advertisement content “C12”. Similarly, the tallying unit 145 tallies up the advertisement scores for all pieces of the advertisement content narrowed by the extracting unit 146.

Extracting Unit 146

The extracting unit 146 extracts the advertisement content as the delivery candidates from the advertisement content group stored in the advertisement content storage unit 121, based on various types of conditions.

Specifically, from the advertisement content group stored in the advertisement content storage unit 121, the extracting unit 146 according to the embodiment first extracts, as a first advertisement content group, the predetermined number of (e.g., several ten thousand) pieces of advertisement content whose targeting conditions match the user attributes of the user (the terminal device 20) who has transmitted the acquisition request of the advertisement content. The above-described extraction processing corresponds to the processing in step S21 illustrated in FIG. 1.

Subsequently, the extracting unit 146 instructs the tallying unit 145 to tally up the advertisement score for each piece of the advertisement content for the first advertisement content group extracted from the advertisement content storage unit 121. The extracting unit 146 extracts, as a second advertisement content group, a predetermined number of (e.g., 100) pieces of advertisement content from the first advertisement content group in the order of the higher advertisement score tallied up by the tallying unit 145.

Delivery Unit 147

The delivery unit 147 delivers any one of the second advertisement content group extracted by the extracting unit 146 to the terminal device 20 as a transmission source of the acquisition request received by the receiving unit 142. Here, several processings for the selection of the advertisement content as the delivery object by the delivery unit 147 are considered. Hereinafter, the selection processing of the advertisement content by the delivery unit 147 will be described, taking one example.

For example, the delivery unit 147 may deliver, as the delivery object, the advertisement content having the highest “bidding price”, the advertisement content having the highest “CTR”, which are stored in the advertisement content storage unit 121, or the advertisement content having the highest value obtained by multiplying the “bidding price” by the “CTR” or adding the “bidding price” and the “CTR”. Moreover, for example, the delivery unit 147 may deliver, as the delivery object, the advertisement content having a high matching degree between a keyword included in the web page displayed together with the advertisement content in the terminal device 20, and the targeting condition and the keyword stored in the advertisement content storage unit 121. Moreover, for example, the delivery unit 147 may deliver, as the delivery object, the advertisement content having a high matching degree between a search keyword input to a search engine by the user of the terminal device 20, and the targeting condition and the keyword stored in the advertisement content storage unit 121. Moreover, for example, the delivery unit 147 may select the advertisement content as the delivery object in view of all of the “bidding price”, the “CTR”, and the “matching degrees” to the keyword of the web page and the search keyword. The above-described selection processings by the delivery unit 147 may be performed by the extracting unit 146.

When performing the selection processing of the advertisement content, the delivery unit 147 may use a predicted CTR predicted from a prediction model of the CTR or the like in place of using the actual CTR itself stored in the advertisement content storage unit 121. The above-described predicted CTR is predicted, for example, based on a type of the advertisement content, a type of the web page on which the advertisement content is displayed, and the like. Moreover, a plurality of pieces of advertisement content may be displayed on the web page delivered to the terminal device 20. In this case, the delivery unit 147 selects a number of pieces of advertisement content as the delivery objects to be displayed on the web page from the advertisement content group as the delivery candidates, and delivers the selected advertisement content to the terminal device 20.

Moreover, when the advertisement content delivered to the terminal device 20 is clicked on by the user, the delivery unit 147 receives a click notification indicating that the advertisement content is clicked on from the terminal device 20. In this case, the delivery unit 147 updates the CTR in the advertisement content storage unit 121 corresponding to the clicked advertisement content, based on the click notification. Specifically, the delivery unit 147 retains a total number of times of delivery, and a total number of times of click for each piece of the advertisement content. The delivery unit 147 divides the “total number of times of click” by the “total number of times of delivery” to thereby calculate the CTR periodically (e.g., every hour, every day), and update the CTR of each piece of the advertisement content stored in the advertisement content storage unit 121. Moreover, the delivery unit 147 updates the presence/absence of click of the delivery history storage unit 131, based on the click notification.

4. Virtual CTR Calculation Processing Procedure

Next, referring to FIG. 7, a procedure of the virtual CTR calculation processing by the advertisement delivery device 100 according to the embodiment will be described. FIG. 7 is a flowchart illustrating the virtual CTR calculation processing by the advertisement delivery device 100 according to the embodiment.

As illustrated in FIG. 7, the calculating unit 144 of the advertisement delivery device 100 determines whether or not it is calculation timing of the virtual CTR (step S101). If it is not the calculation timing of the virtual CTR (step S101; No), the calculating unit 144 waits until the calculation timing.

On the other hand, if it is the calculation timing of the virtual CTR (step S101; Yes), the calculating unit 144 sets, as the processing object, one of the unprocessed user attributes among the user attributes included in the delivery object user attribute of the delivery history storage unit 131 (step S102). For example, if the delivery history storage unit 131 is in the state illustrated in FIG. 5, the calculating unit 144 sets the user attribute “male” or the like as the processing object.

Subsequently, the calculating unit 144 counts the number of times at which the users having the user attribute as the processing object have clicked on the advertisement content (the number of times of click) (step S103). For example, the calculating unit 144 counts a record number of “1 (present)” of the presence/absence of click among records in which the user attribute as the processing object is included in the delivery object user attribute, referring to the delivery history storage unit 131.

Subsequently, the calculating unit 144 divides the number of times of click counted in step S103 by the record number of the delivery history storage unit 131, in which the user attribute as the processing object is included in the delivery object user attribute, to thereby calculate the virtual CTR corresponding to the user attribute as the processing object (Step S104).

Subsequently, the calculating unit 144 determines whether or not all the user attributes included in the delivery object user attribute of the delivery history storage unit 131 have been processed (step S105). If the unprocessed user attribute is present (step S105, No), the calculating unit 144 returns to step S102 to perform steps S103 and S104 for the unprocessed user attribute.

On the other hand, if all the user attributes have been processed (step S105; Yes), the calculating unit 144 stores the virtual CTR for each user attribute calculated in Step S104 in the virtual CTR storage unit 132 (step s106).

5. Advertisement Delivery Processing Procedure

Next, referring to FIG. 8, a procedure of advertisement delivery processing by the advertisement delivery device 100 according to the embodiment will be described. FIG. 8 is a flowchart illustrating the advertisement delivery processing procedure by the advertisement delivery device 100 according to the embodiment.

As illustrated in FIG. 8, the receiving unit 142 of the advertisement delivery device 100 determines whether or not the acquisition request of the advertisement content has been received from the terminal device 20 or the information providing device 30 (step S201). If the acquisition request of the advertisement content has not been received (step S201; No), the receiving unit 142 waits until the acquisition request is received.

On the other hand, if the acquisition request of the advertisement content has been received by the receiving unit 142 (step S101; Yes), the extracting unit 146 extracts, from the advertisement content group stored in the advertisement content storage unit 121, the first advertisement content group in which the targeting condition matches the user attribute of the user who has transmitted the acquisition request of the advertisement content (step S202).

Subsequently, the tallying unit 145 tallies up the advertisement scores of the first advertisement content group extracted by the extracting unit 146, using the virtual CTRs stored in the virtual CTR storage unit 132 (step S203). Specifically, for each piece of the advertisement content, the tallying unit 145 acquires, from the virtual CTR storage unit 132, the virtual CTRs corresponding to the targeting condition of the relevant advertisement content to tally up the sum of the acquired virtual CTRs as the advertisement score.

Subsequently, the extracting unit 146 extracts, as the second advertisement content group, the predetermined number of pieces of advertisement content from the first advertisement content group extracted in step s202 in the order of the higher advertisement score tallied up by the tallying unit 145 (step S204).

Subsequently, the delivery unit 147 selects the advertisement content as the delivery object from the second advertisement content group extracted by the extracting unit 146, based on the bidding price and the CTR stored in the advertisement content storage unit 121 (step S205). The delivery unit 147 delivers the selected advertisement content to the terminal device 20 or the information providing device 30 that has transmitted the acquired request in step S201 (step S206).

6. Modification

The advertisement delivery device 100 according to the above-described embodiment may be carried out in various different embodiments other than the above-described embodiment. Hereinafter, the other embodiments of the above-described advertisement delivery device 100 will be described.

6-1. Virtual CTR Model in View of Keyword

In the above-described embodiment, the example has been described, in which the virtual CTR indicating “what the user attribute of the user who tends to click on the advertisement content is, and at what rate the relevant user clicks on the advertisement content” without considering a type (genre) of the advertisement content. However, even the users having the same attribute are different in whether or not they tend to click on the advertisement, depending on the type of the advertisement content. Consequently, the advertisement delivery device 100 may calculate a virtual CTR indicating “what the user attribute of the user who tends to click on the advertisement content is, what the keyword included in the advertisement content that the user tends to click on is, and at what rate the relevant user clicks on the relevant advertisement content” in view of the type (genre) of the advertisement content. That is, the advertisement delivery device 100 may calculate the virtual CTR on the basis of the single user attribute included in the delivery object user attribute of the delivery history storage unit 131 and for each keyword of the advertisement content delivered to the users having the relevant user attribute. Hereinafter, this point will be specifically described.

First, as in the example described with reference to FIGS. 1 to 8, on the basis of the single user attribute included in the delivery object user attribute, the calculating unit 144 acquires, from the delivery history unit 131, the delivery histories (combinations of the advertisement content, the delivery object user attribute and the presence/absence of click) including the relevant user attribute. Moreover, the calculating unit 144 acquires, from the advertisement content storage unit 121, the keyword corresponding to the delivery advertisement content acquired from the delivery history storage unit 131.

For example, it is assumed that the advertisement content storage unit 121 is in the state illustrated in FIG. 4, that the delivery history storage unit 131 is in the state illustrated in FIG. 5, and that the user attribute as the processing object by the calculating unit 144 is the “male”. In this case, the calculating unit 144 acquires the delivery histories on the first to fourth, seventh, and eighth lines from the delivery history storage unit 131 illustrated in FIG. 5. The calculating unit 144 acquires, from the advertisement content storage unit 121, the keywords “car”, “black” and the like corresponding to the advertisement content “C11” illustrated in the delivery history on the first line. Similarly, the calculating unit 144 also acquires the keywords corresponding to the advertisement content, “C31”, “C12”, “c13”, and “C14” illustrated in the delivery histories on the second to fourth, seventh and eighth lines.

The calculating unit 144 performs machine learning (e.g., regression analysis) to a relationship between the “presence/absence of click” acquired from the delivery history storage unit 131, and the “keyword” acquired from the advertisement content storage unit 121 to thereby generate a model indicating what keyword the advertisement content that the users having the predetermined user attribute tend to click on (e.g. a model obtained by the regression analysis) includes, for each user attribute. When one or more keywords are input, this model outputs the virtual CTR indicating at what rate the relevant advertisement content including the keywords is clicked on by the users. While the virtual CTR obtained from the above-described model is different from the virtual CTR described in FIGS. 1 to 8, hereinafter, it may be represented as the “virtual CTR”, and the above-described model may be represented as a virtual CTR model.

Model generation processing by the calculating unit 144 will be described, taking the regression analysis as one example. Here, the calculating unit 144 performs the regression analysis for the user attribute “male” as the processing object with the presence/absence of click used as a dependent variable (objective variable), and with each of the keywords included in the advertisement content used as an independent variable (explanatory variable) to thereby generate a regression expression (virtual CTR model) in which the presence/absence of click is represented by each of the keywords. In this case, for the keyword that is oftener included in the advertisement content whose “presence/absence of click” is “1 (present)”, and is less often included in the advertisement content whose “presence/absence of click” is “0 (absent)”, the calculating unit 144 sets a coefficient corresponding to the above-described keyword (a coefficient of the independent variable in the regression expression) to a larger value. On the other hand, for the keyword that is less often included in the advertisement content whose “presence/absence of click” is “1 (present)”, and is oftener included in the advertisement content whose “presence/absence of click” is “0 (absent)”, the calculating unit 144 sets the coefficient corresponding to the above-described keyword to a smaller value.

For example, if the users having the user attribute “male” tend to often click on the advertisement content including the keyword “car”, and tend to less often click on the advertisement content including a keyword “cosmetics”, the coefficient of the keyword “car” is a large value, and the coefficient of the keyword “cosmetics” is a small value in the regression expression (the virtual CTR model) corresponding to the user attribute “male”. That is, the coefficient corresponding to each of the keywords included in the virtual CTR model corresponds to the virtual CTR indicating whether or not the users tend to click on the advertisement content including the relevant keyword.

In this manner, the calculating unit 144 generates the above-described virtual CTR model for each user attribute, and stores the generated virtual CTR model in the virtual CTR storage unit 132. In this example, the “virtual CTR” of the virtual CTR storage unit 132 illustrated in FIG. 6 is the “virtual CTR model”. Here, in FIG. 9, the virtual CTR models generated by the calculating unit 144 are schematically illustrated. In FIG. 9, as one example, virtual CTR models M11 to M13 corresponding to the user attributes “male”, “female”, “10's”, which virtual CTR models are generated by the calculating unit 144, are illustrated. The virtual CTR model M11 corresponding to the user attribute “male” illustrated in FIG. 9 includes the coefficient (the virtual CTR) of the keyword “car” “0.03”, the coefficient (the virtual CTR) of the keyword “sport” “0.01”, the coefficient of the keyword “cosmetics” “0.001” and the like.

If the keywords are input, these virtual CTR models M11 to M13 each output a value obtained by adding the coefficients (the virtual CTRs) corresponding to the relevant keywords. For example, if the keywords “car” and “sport” are input to the virtual CTR model M11, “0.04”, which is an addition result of the coefficient (the virtual CTR) “0.03” and the coefficient (the virtual CTR) “0.01” corresponding to the respective keywords, is output.

The tallying unit 145 tallies up the advertisement score of each piece of the advertisement content, using the virtual CTR model for each of the user attributes generated by the calculating unit 144. Specifically, for each piece of the advertisement content included in the first advertisement content group and narrowed by the extracting unit 146, the tallying unit 145 acquires the targeting condition corresponding to the relevant advertisement content from the advertisement content storage unit 121. The tallying unit 145 acquires, from the virtual CTR storage unit 132, each of the virtual CTR models corresponding to each of the targeting conditions acquired from the advertisement content storage unit 121, and inputs the keyword corresponding to the advertisement content to each of the acquired virtual CTR models. The tallying unit 145 then tallies up a sum of the virtual CTRs output from each of the virtual CTR models as the advertisement score.

For example, it is assumed that the advertisement content storage unit 121 is in the state illustrated in FIG. 4, and that the virtual CTR storage unit 132 is in a state illustrated in FIG. 9. Also, it is assumed that the advertisement content “C13” is included in the advertisement content group resulting from narrowing by the extracting unit 146. In this case, the tallying unit 145 acquires the targeting condition “male, 10's” corresponding to the advertisement content “C13” from the advertisement content storage unit 121. Subsequently, the tallying unit 145 inputs the keywords “car” and “sport” of the advertisement content “C13” to the virtual CTR model M11 corresponding to the targeting condition “male” to thereby obtain the virtual CTR “0.04”, Moreover, the tallying unit 145 inputs the keywords “car” and “sport” of the advertisement content “C13” to the virtual CTR model M13 corresponding to the targeting condition “10's” to thereby obtain the virtual CTR “0.05”. The tallying unit 145 adds the virtual CTRs “0.04” and “0.05” obtained from the virtual CTR models Mil and M13 to thereby find the advertisement score “0.09” corresponding to the advertisement content “C13”. Similarly, the tallying unit 145 tallies up the advertisement scores for all pieces of the advertisement content included in the advertisement content group G11 resulting from narrowing by the extracting unit 146.

In this manner, the advertisement delivery device 100 according to the embodiment generates the virtual CTR model in view of the user attribute and the keyword included in the advertisement content, and finds the virtual CTR of each piece of advertisement content, using the relevant virtual CTR model to thereby find the high-precision advertisement score indicating whether or not each piece of advertisement content tends to be clicked on by the users. That is, since the advertisement delivery device 100 can narrow the advertisement content to the advertisement content group having the high advertisement effect with a high precision, the advertisement content having the high advertisement effect can be delivered accurately.

The calculating unit 144 may correct the coefficient of the keyword in the above-described virtual CTR model in accordance with an appearance frequency of the keyword in the advertisement content or a degree of rarity of the keyword. Specifically, with the keyword having the higher appearance frequency in the advertisement content clicked on by the users, the calculating unit 144 corrects the coefficient corresponding to the relevant keyword to a higher value. Moreover, with the keyword that appears in the advertisement content clicked on by the users, and has the lower appearance frequency in the other advertisement content, the calculating unit 144 corrects the coefficient corresponding to the relevant keyword to a higher value. For example, the calculating unit 144 finds a degree of importance (the appearance frequency, the degree of rarity) for each keyword, using a method such as tf-idf (term frequency inverse document frequency), and corrects the coefficient of the virtual CTR model, based on the found degree of importance.

6-2. Virtual CTR and Bidding Price

Moreover, in the above-described embodiment, the example where the tallying unit 145 tallies up the sum of the virtual CTRs as the advertisement score has been described. The tallying unit 145, however, may tally up the advertisement score, using not only the virtual CTR but the bidding price of the advertisement content. For example, for each piece of advertisement content, the tallying unit 145 may tally up, as the advertisement score, a value obtained by multiplying the sum of the virtual CTRs by the bidding price of the relevant advertisement content, or adding the bidding price to the sum of the virtual CTRs. This enables the advertisement delivery device 100 to preferentially deliver the advertisement content that not only has the high advertisement effect but can bring about higher advertisement income.

6-3. Virtual CTR for Each Combination of User Attributes

Moreover, in the above-described embodiment, as in the example illustrated in FIG. 6, the example in which the virtual CTR is calculated on the basis of the single user attribute has been described. However, the calculating unit 144 may calculate the virtual CTR for each combination of the plurality of user attributes. In this case, on the basis of the plurality of user attributes included in the delivery object user attribute, the calculating unit 144 acquires the delivery histories including the relevant plurality of user attributes from the delivery history storage unit 131. For example, if a combination of the user attributes “male” and “10's” is set as a processing object, the calculating unit 144 acquires the delivery histories on the first, second and seventh lines from the delivery history storage unit 131 illustrated in FIG. 5. Processing after this is similar to the above-described processing, and the calculating unit 144 stores the virtual CTR in the virtual CTR storage unit 132 for each combination of the plurality of user attributes. In the case of this example, the tallying unit 145 acquires, from the virtual CTR storage unit 132, the virtual CTRs in which a combination of the targeting conditions of the advertisement content matches the combination of the user attributes to thereby tally up the advertisement score for each piece of the advertisement content.

In this manner, since the advertisement delivery device 100 can tally up the advertisement score with a higher precision by calculating the virtual CTR for each combination of the plurality of user attributes, the advertisement delivery device 100 can accurately deliver the advertisement content having the higher advertisement effect.

6-4. Extraction Processing

Moreover, in the above-described embodiment, the example has been described, in which as illustrated in FIG. 1, the extracting unit 146 first narrows the advertisement content, based on the targeting condition (step S21), and next, narrows the advertisement content, based on the virtual CTR (step S22), and finally, selects the advertisement content as the delivery object, based on the actual CTR or the bidding price. However, the advertisement delivery, device 100 is not limited to this example, but the extracting unit 146 may first narrow the advertisement content, based on the virtual CTR, and next, may select the advertisement content as the delivery object, based on the actual CTR or the bidding price. Alternatively, the extracting unit 146 may first narrow the advertisement content, based on the targeting condition, and next, may select the advertisement content as the delivery object, based on the virtual CTR. Alternatively, the extracting unit 146 may select, from the advertisement content stored in the advertisement content storage unit 121, the advertisement content as the delivery object, based on the virtual CTR without performing narrowing.

6-5. Others

Moreover, in the respective processings described in the above-described embodiment, all or a part of each of the processings described as ones to be automatically performed can also be performed manually, or all or a part of each of the processings described as ones to be manually performed can also be automatically performed by publicly known methods. In addition to the foregoing, the processing procedures, the specific names, and the information including various types of data and parameters described in the foregoing and illustrated in the drawings can be arbitrarily changed except for a specifically mentioned case.

Moreover, the respective components of the respective illustrated devices are functionally conceptual, and are not necessarily required to be physically configured as illustrated. That is, a specific form of distribution/integration of the respective devices is not limited to the illustration, but all or a part thereof can be configured by being functionally or physically distributed/integrated in arbitrary units in accordance with various loads, use situations and the like.

For example, the advertisement content storage unit 121, the delivery history storage unit 131, and the virtual CTR storage unit 132 illustrated in FIG. 3 may not be retained by the advertisement delivery device 100, but may be retained by a storage server or the like. In this case, the advertisement delivery device 100 acquires the advertisement content by accessing the storage server.

Moreover, for example, the above-described advertisement delivery device 100 may be configured integrally with the information providing device 30 that delivers the web pages. Moreover, the advertisement delivery device 100 may be an advertisement extraction device that performs only the advertisement extraction processing by the advertisement extracting unit 143 without performing the providing processing of the advertisement content. In this case, the advertisement extraction device, at least, does not have the submission acceptor 141 and the delivery unit 147. The advertisement delivery device having the submission acceptor 141 and the delivery unit 147 delivers the advertisement content extracted by the advertisement extraction device to the terminal device 20 or the like.

7. Effects

As described above, the advertisement delivery device 100 according to the embodiment has the calculating unit 144, the tallying unit 145, and the extracting unit 146. The calculating unit 144 calculates the virtual CTR (corresponds to one example of a “hypothetical advertisement effect”) for each user attribute of the user, based on the delivery history regarding the advertisement content delivery to the terminal device 20 used by the relevant user. Moreover, for each piece of the advertisement content whose targeting condition (corresponds to one example of a “user attribute as the delivery object”) has been decided in advance, the tallying unit 145 tallies up the advertisement effect, using the virtual CTR corresponding to the targeting condition in the relevant advertisement content among the virtual CTRs for each user attribute calculated by the calculating unit 144. The extracting unit 146 extracts the advertisement content as the delivery candidate, based on the advertisement effect tallied up by the tallying unit 145.

This allows the advertisement delivery device 100 according to the embodiment to narrow the advertisement content as the delivery candidates, based on the virtual CTR for each of the user attributes obtained from the delivery histories, and thus, as a result, the advertisement content having the high advertisement effect can be delivered.

Moreover, in the advertisement delivery device 100 according to the embodiment, the calculating unit 144 calculates, as the virtual CTR, the rate of the number of times at which the advertisement content is selected by the user to the number of times of delivery at which the advertisement content is delivered to the relevant user. Moreover, for each piece of the advertisement content, the tallying unit 145 tallies up the sum of the virtual CTRs corresponding to the targeting condition in the relevant advertisement content.

This allows the advertisement delivery device 100 according to the embodiment to narrow the advertisement content as the delivery candidates, based on the virtual CTR indicating whether or not it is the user attribute that facilitates click on the advertisement content, and thus, as a result, the advertisement content having the high advertisement effect can be delivered.

Moreover, in the advertisement delivery device 100 according to the embodiment, the calculating unit 144 calculates the virtual CTR for each combination of the plurality of user attributes, based on the delivery histories.

This enables the advertisement delivery device 100 according to the embodiment to tally up the advertisement score of each piece of the advertisement content with a high precision, and thus, the advertisement content having the high advertisement effect can be accurately delivered.

Moreover, in the advertisement delivery device 100 according to the embodiment, the calculating unit 144 calculates the virtual CTR for each user attribute, and for each keyword indicating characteristics of the advertisement content delivered to the users having the relevant user attribute. Moreover, for each piece of the advertisement content, the tallying unit 145 tallies up the advertisement effect, using the virtual CTR corresponding to the targeting condition and the keyword in the relevant advertisement content among the virtual CTRs for each user attribute calculated by the calculating unit 144, and for each keyword.

This enables the advertisement delivery device 100 according to the embodiment to find the advertisement score varying in respective pieces of the advertisement content with a high precision, and thus, the advertisement content having the high advertisement effect can be accurately delivered.

Moreover, in the advertisement delivery device 100 according to the embodiment, the delivery unit 147 delivers, to the terminal device 20, the advertisement content decided, based on the bidding price specified by the advertiser, or based on the actual advertisement effect of the advertisement content, among the advertisement content as the delivery objects extracted by the extracting unit 146.

This enables the advertisement delivery device 100 according to the embodiment to further deliver the advertisement content high in earning and the advertisement content that the user tends to click on, among the advertisement content having the high advertisement effect extracted by the extracting unit 146.

Moreover, the above-described advertisement delivery device 100 may be implemented on a plurality of sever computers, or may be implemented by calling an external platform or the like through API (Application Programming Interface), network computing or the like, depending on the function, so that the configuration can be changed flexibly.

Moreover, “means” described in claims can be interpreted as a part (a section, a module, a unit), a “circuit” or the like. For example, calculation means can be interpreted as a calculating unit or a calculation circuit.

According to one aspect of the embodiment, there is exerted an effect that the advertisement content having the high advertisement effect can be delivered.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement extraction device comprising:
a calculating unit configured to calculate a hypothetical advertisement effect for each user attribute of a user, based on a delivery history regarding advertisement content delivery to a terminal device used by the user;
a tallying unit configured to tally up an advertisement effect for each piece of advertisement content in which a user attribute as a delivery object has been decided, the tallying unit tallying up the advertisement effect through the use of the hypothetical advertisement effect corresponding to the user attribute as the delivery object in the advertisement content among the hypothetical advertisement effects for each user attribute calculated by the calculating unit; and
an extracting unit configured to extract the advertisement content as a delivery candidate, based on the advertisement effect tallied up by the tallying unit.

2. The advertisement extraction device according to claim 1,
wherein the calculating unit calculates, as the hypothetical advertisement effect, a rate of a number of times at which the advertisement content has been selected by the user to a number of times of delivery at which the advertisement content has been delivered to the user having the user attribute, and
for each piece of the advertisement content, the tallying unit tallies up a summation of the hypothetical advertisement effects corresponding to the user attributes as the delivery objects in the advertisement content.

3. The advertisement extraction device according to claim 1,
wherein the calculating unit calculates the hypothetical advertisement effect for each combination of the plurality of user attributes, based on the delivery history.

4. The advertisement extraction device according to claim 1,
wherein the calculating unit calculates the hypothetical advertisement effect for each of the user attributes, and for each keyword indicating characteristics of the advertisement content delivered to the user having the relevant user attribute, and
the tallying unit tallies up the advertisement effect for each piece of the advertisement content, the tallying unit tallying up the advertisement effect through the use of the hypothetical advertisement effect corresponding to the user attribute as the delivery object and the keyword in the relevant advertisement content among the hypothetical advertisement effects for each of the user attributes and for each of the keywords, which are calculated by the calculating unit.

5. The advertisement extraction device according to claim 1, further comprising a delivery unit configured to deliver, to the terminal device, the advertisement content decided, based on a bidding price specified by an advertiser or an actual advertisement effect of the advertisement content, in the advertisement content as the delivery candidates extracted by the extracting unit.

6. An advertisement extraction method executed by an advertisement extraction device, comprising:
calculating a hypothetical advertisement effect for each user attribute of a user, based on a delivery history regarding advertisement content delivery to a terminal device used by the relevant user;
tallying up an advertisement effect for each piece of advertisement content in which a user attribute as a delivery object has been decided, the tallying being performed through the use of the hypothetical advertisement effect corresponding to the user attribute as the delivery object in the advertisement content among the hypothetical advertisement effects for each user attribute calculated in the calculating step; and
extracting the advertisement content as a delivery candidate, based on the advertisement effect tallied up in the tallying step.

7. A non-transitory computer-readable storage medium having stored therein an executable advertisement extraction program causing a computer to execute a process, the process comprising:
calculating a hypothetical advertisement effect for each user attribute of a user, based on a delivery history regarding advertisement content delivery to a terminal device used by the relevant user;
tallying up an advertisement effect for each piece of advertisement content in which a user attribute as a delivery object has been decided, the tallying being performed through the use of the hypothetical advertisement effect corresponding to the user attribute as the delivery object in the advertisement content among the hypothetical advertisement effects for each user attribute calculated in the calculating step; and
extracting the advertisement content as a delivery candidate, based on the advertisement effect tallied up in the tallying step.
